(19) United States
(12) Patent Application Publication
(10) Pub. No.: US 2026/0260394 A1
(43) Pub. Date: Sep. 3, 2026

(54) Method for Operating a Display Unit for Extended Reality and Display Unit

(71) Applicant: Bayerische Motoren Werke Aktiengesellschaft, Muenchen (DE)

(72) Inventors: Pascal DOS SANTOS SALGUEIRO, San Francisco, CA (US); Finn LEHNERT, Muenchen (DE); Markus PREISINGER, Windorf (DE)

(21) Appl. No.: 19/552,312

(22) Filed: Feb. 27, 2026

(30) Foreign Application Priority Data
Feb. 28, 2025 (DE) 10 2025 107 663.4

(51) Int. Cl. G06T 11/00; G06T 7/215; G06T 7/80

(52) U.S. Cl. CPC G06T 11/00; G06T 7/215; G06T 7/80; G06T 2207/20081; G06T 2207/30268

(57) ABSTRACT

A method operates a display unit for extended reality that is introduced into an interior of a vehicle. A movement of the display unit in world coordinates is determined. First coordinate data corresponding to the movement of the display unit in the world coordinates are generated. Images are continuously captured with a camera of the display unit, which images include at least part of the vehicle interior. Image data corresponding to the images are generated. A movement of the display unit in a coordinate system of the vehicle interior is determined based on the image data. Second coordinate data corresponding to the movement of the display unit in the coordinate system of the vehicle interior are generated. A movement of the vehicle in the world coordinates is determined from the difference between the first coordinate data and the second coordinate data. Third coordinate data corresponding to the movement of the vehicle in the world coordinates are generated. A position and an orientation of the display unit in the vehicle interior are determined taking the third coordinate data into account.

### CROSS REFERENCE TO RELATED APPLICATION

This application claims priority under 35 U.S.C. § 119 from German Patent Application No. 10 2025 107 663.4, filed Feb. 28, 2025, the entire disclosure of which is herein expressly incorporated by reference.

### BACKGROUND AND SUMMARY

The invention relates to a method for operating a display unit for extended reality. The invention further relates to a display unit for extended reality.

Extended Reality (XR) is a collective term for technologies such as Virtual Reality (VR), Augmented Reality (AR) and mixed forms (Mixed Reality, MR), which integrate digital content into the physical world or generate immersive digital environments. Head-Mounted Displays (HMD), such as XR Headsets or Smart Glasses, and mobile terminals, such as smartphones or tablet computers, for example, can be used as display units for extended reality. In order that the integration of digital content into the physical world can take place seamlessly, the display unit must determine its position and orientation precisely and in real time. Known display units calculate their position and orientation using various sensor data, for example movement data from an inertial measurement unit (Internal Measurement Unit, IMU) built into the display unit and images from a camera of the display unit. To calculate the position and orientation of the display unit, movements are defined in each case in a local coordinate system of one of the sensors and transferred, i.e. merged, into a common coordinate system. If this common coordinate system is not stationary, such as for example the coordinate system of a vehicle interior which moves in relation to a world coordinate system, this can lead to problems. In such a highly dynamic environment, the effect can occur, for example, whereby virtual objects suddenly “drive away” or are left behind.

The object of the invention is to provide a method for operating a display unit for extended reality and a display unit for extended reality, which reliably and very accurately determine a position and an orientation of the display unit in particular in a highly dynamic environment.

This object is achieved by a method and a display having the features of the independent claims. Advantageous developments are specified in the dependent claims.

The proposed method for operating a display unit for extended reality comprises at least the following steps: The display unit is introduced into an interior of a vehicle. A movement of the display unit in world coordinates is determined. First coordinate data corresponding to the movement of the display unit in the world coordinates are generated. Images are continuously captured with a camera of the display unit, which images include at least part of the vehicle interior. Image data corresponding to the images are generated. A movement of the display unit in a coordinate system of the vehicle interior is determined on the basis of the image data. Second coordinate data corresponding to the movement of the display unit in the coordinate system of the vehicle interior are generated. A movement of the vehicle in the world coordinates is determined from the difference between the first coordinate data and the second coordinate data. Third coordinate data corresponding to the movement of the vehicle in the world coordinates are generated. A position and an orientation of the display unit in the vehicle interior are determined taking the third coordinate data into account.

With the aid of the proposed method, the display unit can be used in the vehicle interior, for example, when the vehicle is moving. To define the position and the orientation of the display unit in the moving vehicle interior, initially the movement of the display unit in the world coordinates is determined, i.e. relative to a stationary reference system in relation to which the vehicle is moving. Then, using the image data, the movement of the display unit in the coordinate system of the vehicle interior is determined, i.e. relative to a reference system which is not moving relative to the vehicle. The movement of the vehicle relative to the stationary reference system is determined from the difference between these two movements. The movement of the vehicle is then used to define the position and the orientation of the display unit in the vehicle interior. For example, the movement of the vehicle is factored out of the movement of the display unit relative to the stationary reference system, in order to determine the movement of the display unit in the vehicle interior.

Definition of the position and the orientation of the display unit in the vehicle interior using the image data is independent of the movement of the vehicle. However, the image data can be captured and processed by cameras with the resolution required for this only at a rate of 10 Hz to 30 Hz, at most 50 Hz, since determination of the movement using images is very intensive in computational terms. By contrast, inertial measurement units have sampling rates of 100 Hz up to 500 Hz and can therefore define the movement of the display unit much more accurately and with a significantly smaller requirement for computing power. However, these can only determine a movement relative to the stationary reference system. In the proposed method, the movement of the display unit in the vehicle interior, determined using the image data, is instead now used to determine the movement of the vehicle. Since typical accelerations of the vehicle take place less quickly and jerkily than typical accelerations of the display unit, the low processing rate of the image data is not detrimental for this purpose. The movement of the display unit in the vehicle interior can then be defined with the accuracy with which the movement of the display unit in the stationary reference system can be defined, for example at the high sampling rate of an inertial measurement unit. Thus the position and the orientation of the display unit can also be determined reliably and very accurately in a highly dynamic environment.

In this document, vehicle is understood in particular to be a motor vehicle, for example a passenger car or a truck. However, the vehicle can also be another road vehicle, an aircraft or a watercraft.

In one embodiment, the movement of the vehicle in the world coordinates is determined from the difference between the first coordinate data and the second coordinate data using a filter and/or a trained machine learning model. For example, the difference between the first coordinate data and the second coordinate data can be processed using an interpolation, a smoothing, a bandpass filter or a Kalman filter, in order to obtain the movement of the vehicle in the world coordinates. Alternatively or additionally, the trained machine learning model can be used in a comparable function. With the aid of the aforementioned methods, measurement noise can be reduced, jumps can be evened out, outliers can be filtered out and missing values can be supplemented in a useful manner, for example. This ensures that the movement of the vehicle in the world coordinates can be determined particularly accurately.

In one embodiment, the movement of the display unit in the world coordinates is determined using an inertial measurement unit of the display unit. Inertial measurement units have a sampling rate in the range of 100 Hz up to 500 Hz. This makes it possible to define the movement of the display unit in the world coordinate system particularly accurately. The position and the orientation of the display unit in the vehicle interior is ultimately determined from the movement of the display unit in the world coordinate system. Thus the position and the orientation of the display unit in the vehicle interior likewise can be determined particularly accurately using the inertial measurement unit.

In one embodiment, the images continuously captured by the camera of the display unit include a region outside the vehicle. The movement of the display unit in the world coordinates can be determined taking the image data into account. In such an embodiment, the image data are used to determine the movement of the display unit in the stationary reference system. This can be done in particular in conjunction with an inertial measurement unit, in order to further increase the accuracy with which the movement of the display unit in the world coordinates is determined. Alternatively, it is also possible to use only the camera of the display unit to determine the movement of the display unit both relative to the vehicle interior and relative to the stationary reference system. Such an embodiment does not require an inertial measurement unit, for example.

In one embodiment, first partial image data are generated from the image data using an image segmentation, which partial image data correspond to image regions of the images which each include part of the region outside the vehicle. The movement of the display unit in the world coordinates is determined taking the first partial image data into account. In such an embodiment, it is initially determined which image regions in each case show part of the region outside the vehicle. These image regions are then used to determine the movement of the display unit relative to the stationary reference system, for example using optical flow. The image segmentation prevents points in the vehicle interior from accidentally being used to define the movement of the display unit in the world coordinates, for example.

In one embodiment, the positions of first image points, which correspond to points in the region outside the vehicle, in successive images are determined on the basis of the image data, in order to determine the movement of the display unit in the world coordinates. For example, tracking is performed to see how the first image points in successive images move, in order to infer the movement of the camera and thus of the display unit. Such tracking is robust and can therefore be used to very accurately determine the movement of the display unit relative to the stationary reference system. The first image points can be determined on the basis of the first image data, for example by selecting image points only in the image regions which include part of the region outside the vehicle.

In one embodiment, the first image points are determined by determining which of the image points correspond to points in the region outside the vehicle using a cluster analysis for a plurality of image points in successive images. The cluster analysis represents in particular a computationally less intensive alternative to the image segmentation, but can also be used in a supplementary manner. In this embodiment, positions are in each case initially determined for the plurality of image points, for example in two-dimensional or three-dimensional coordinates relative to the camera. These positions and/or variables derived therefrom, for example speeds, are used as the basis for the cluster analysis. By means of the cluster analysis, image points which correspond to points in the region outside the vehicle are then separated from image points which correspond to points in the vehicle interior. The image points which correspond to points in the region outside the vehicle are used as the first image points.

In one embodiment, second partial image data are generated from the image data using an image segmentation, which partial image data correspond to image regions of the images which each include at least part of the vehicle interior. The movement of the display unit in the coordinate system of the vehicle interior is determined taking the second partial image data into account. In such an embodiment, the images continuously captured by the camera of the display unit preferably include the region outside the vehicle. It is initially determined which image regions in each case show part of the vehicle interior. These image regions are then used to determine the movement of the display unit relative to the vehicle interior, for example using optical flow. The image segmentation prevents points outside the vehicle interior from accidentally being used to define the movement of the display unit in the coordinate system of the vehicle interior, for example.

In one embodiment, the positions of second image points, which correspond to points in the vehicle interior, in successive images are determined on the basis of the image data, in order to determine the movement of the display unit in the coordinate system of the vehicle interior. For example, tracking is performed to see how the second image points in successive images move, in order to infer the movement of the camera and thus of the display unit. Such tracking is robust and can therefore be used to very accurately determine the movement of the display unit relative to the vehicle interior. The second image points can be determined on the basis of the second image data, for example by selecting image points only in the image regions which include part of the vehicle interior.

In one embodiment, the second image points are determined by determining which of the image points correspond to points in the vehicle interior using a cluster analysis for a plurality of image points in successive images. Also in this embodiment, the cluster analysis represents in particular a computationally less intensive alternative to the image segmentation, but can also be used in a supplementary manner. In this embodiment, positions are in each case initially determined for the plurality of image points, for example in two-dimensional or three-dimensional coordinates relative to the camera. These positions and/or variables derived therefrom, for example speeds, are used as the basis for the cluster analysis. By means of the cluster analysis, image points which correspond to points in the region outside the vehicle are then separated from image points which correspond to points in the vehicle interior. The image points which correspond to points in the vehicle interior are used as the second image points.

The invention further relates to a display unit for extended reality. The display unit comprises a camera which is designed to continuously capture images and to generate image data corresponding to the images. The display unit further comprises a determining unit which is designed to determine a movement of the display unit in world coordinates and to generate corresponding first coordinate data. The determining unit is additionally designed to determine, on the basis of image data which correspond to images that include at least part of a vehicle interior of a vehicle, a movement of the display unit in a coordinate system of the vehicle interior and to generate corresponding second coordinate data. The determining unit is further designed to determine a movement of the vehicle in the world coordinates from the difference between the first coordinate data and the second coordinate data, to generate corresponding third coordinate data and to determine a position and an orientation of the display unit in the vehicle interior taking the third coordinate data into account.

The display unit has the same advantages as the claimed method. In particular, the display unit can be developed with features which are described in connection with the method in this document. Furthermore, the method can be developed with features which are described in connection with the display unit in this document.

In one embodiment, the display unit comprises an inertial measurement unit which is designed to generate acceleration data which correspond to a movement of the display unit. The determining unit can be designed to determine the movement of the display unit in the world coordinates taking the acceleration data into account. Inertial measurement units have a sampling rate in the range of 100 Hz up to 500 Hz. This makes it possible to define the movement of the display unit in the world coordinate system particularly accurately.

The display unit can comprise several cameras which are aligned in different directions in particular. In such an embodiment, the image data include the images continuously captured by the various cameras.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic depiction of a display unit for extended reality according to an exemplary embodiment;

FIG. 2 is a schematic depiction of a vehicle to illustrate an embodiment of the method for operating a display unit for extended reality;

FIG. 3 shows, in a schematic depiction, graphs to further illustrate the method according to FIG. 2;

FIG. 4 is a schematic depiction of the vehicle to illustrate a further embodiment of the method for operating a display unit for extended reality; and

FIG. 5 shows, in a schematic depiction, graphs to further illustrate the method according to FIG. 4.

### DETAILED DESCRIPTION OF THE DRAWINGS

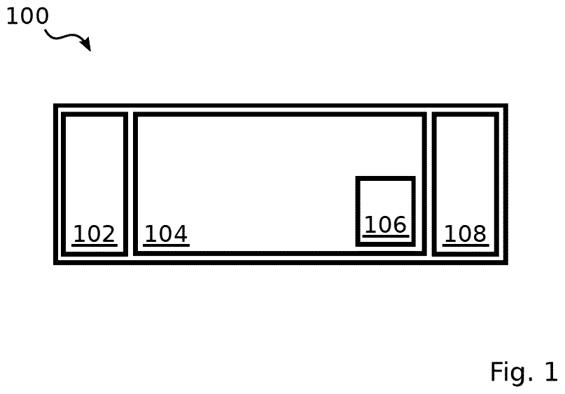

FIG. 1 shows a schematic depiction of a display unit 100 for extended reality according to an exemplary embodiment. The display unit 100 is a head-mounted display or a mobile terminal such as a smartphone or a tablet computer, for example.

The display unit 100 comprises a camera 102, which is designed to continuously capture images and to generate image data corresponding to the images. If the display unit 100 is designed as a head-mounted display, the camera 102 is aligned in such a way, for example, that the camera 102 captures a region in front of a user, when the display unit 100 is used by the user as intended. The camera 102 can capture images at a rate of 10 Hz to 30 Hz, or up to 50 Hz, for example. In this way, all images captured by the camera 102 can be processed by wearable hardware in real time.

The display unit 100 further comprises a determining unit 104, which comprises an inertial measurement unit 106 purely by way of example. The determining unit 104 is designed to determine a movement of the display unit 100 in world coordinates, i. e relative to a stationary reference system. For this purpose, the determining unit 104 uses acceleration data, for example, which are generated by the inertial measurement unit 106 and correspond to a movement of the display unit 100 relative to the stationary reference system. Alternatively or additionally, the determining unit 104 can use the image data generated by the camera 102 to determine the movement of the display unit 100 in the world coordinates. The determining unit 104 generates first coordinate data corresponding to the movement of the display unit 100 in the world coordinates.

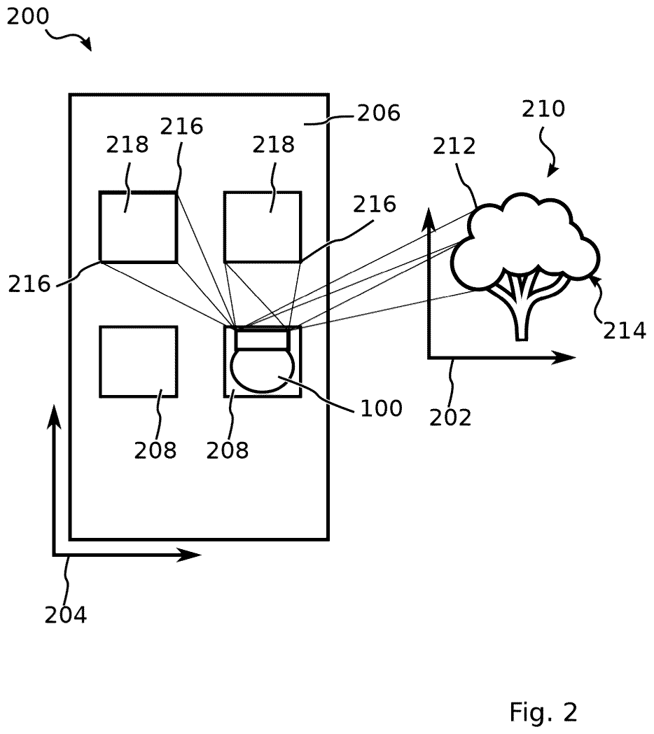

In addition, the determining unit 104 is designed to determine, on the basis of image data which include at least part of a vehicle interior 206 of a vehicle 200 (see FIG. 2), a movement of the display in a coordinate system of the vehicle interior 206, i.e. relative to the vehicle interior 206. For example, the determining unit 104 uses methods such as optical flow and/or tracking to determine, from the image data, a movement of the camera 102 and thus of the display unit 100 relative to the vehicle interior 206. The determining unit 104 generates second coordinate data corresponding to the movement of the display unit 100 in the coordinate system of the vehicle interior 206.

The determining unit 104 is further designed to determine a movement of the vehicle 200 in the world coordinates from the difference between the first coordinate data and the second coordinate data, to generate third coordinate data corresponding thereto and to determine a position and an orientation of the display unit 100 in the vehicle interior 206 taking the third coordinate data into account. The determining unit 104 defines the movement of the vehicle 200 relative to the stationary reference system from the difference between the movement of the display unit 100 relative to the stationary reference system and the movement of the display unit 100 relative to the vehicle interior 206. The determining unit 104 can then subtract the movement of the vehicle 200 from the movement of the display unit 100 relative to the stationary reference system, for example, in order to determine the position and the orientation of the display unit 100 in the vehicle interior 206 very accurately.

The advantage of this procedure lies in the fact that the position and the orientation of the display unit 100 in the vehicle interior 206 can be determined very accurately, without having to process the image data at a high rate, of 100 Hz or more for example. The processing rate of the image data only needs to be high enough that the movement of the vehicle 200 can be determined therefrom. Since the movement of the vehicle 200 is less dynamic and jerky than that of the display unit 100, a lower processing rate, for example 10 Hz to 30 Hz, is sufficient for this. The rate at which the position and the orientation of the display unit 100 in the vehicle interior 206 is determined depends on the rate at which the movement of the display unit 100 in world coordinates is determined. By using an inertial measurement unit 106, rates of 100 Hz or more are therefore possible, which allows the display unit 100 to seamlessly integrate digital content into the physical world.

The display unit 100 can comprise further elements which make display of an extended reality possible. For example, the display unit 100 comprises one or more display elements 108, such as screens, transparent or semi-transparent displays or projection systems, for example, which are designed to blend virtual content into the field of view of a user and to superimpose it on the physical environment of the user. The display unit 100 can further comprise one or more control units, which are designed to activate the display elements to blend the virtual content in. These control units can comprise interfaces via which the control units can communicate with control units and processing units which are remote from the display unit 100, for example with control units and processing units of the vehicle 200.

The display unit 100 can be used to carry out a method for operating a display unit 100 for extended reality. Embodiments of this method are described in greater detail using the following FIGS. 2 to 5.

FIG. 2 shows a schematic depiction of a vehicle 200 to illustrate an embodiment of the method for operating a display unit 100 for extended reality. In addition, FIG. 2 shows first coordinate axes 202 which belong to world coordinates of a stationary reference system. The vehicle 200 moves in relation to the world coordinates. FIG. 2 further shows second coordinate axes 204 which belong to a coordinate system of the vehicle interior 206. The coordinate system of the vehicle interior 206 is stationary in relation to the vehicle interior 206 and moves with the vehicle 200.

The method is described using the display unit 100 according to FIG. 1 purely by way of example. The display unit 100 is introduced into a vehicle interior 206 of the vehicle 200. For example, a user has introduced the display unit 100 into the vehicle interior 206. In FIG. 2, the display unit 100 is used by a passenger on a rear seat 208 of the vehicle 200, purely by way of example.

In the method, images are continuously captured with the camera 102 of the display unit 100, which images include at least part of the vehicle interior 206. In the embodiment according to FIG. 1, the images captured by the camera 102 additionally include a region 210 outside the vehicle 200. The camera 102 generates image data corresponding to the images and makes them available for further processing.

In addition, a movement of the display unit 100 in the world coordinates is determined in the method. In the embodiment according to FIG. 1, this movement is defined with the aid of the camera 102 of the display unit 100. For example, the image data generated by the camera 102 are processed by the determining unit 104, in order to determine first image points in successive images, which image points correspond to points 212 in the region 210 outside the vehicle 200. For example, the determining unit 104 can carry out an image segmentation, in order to determine image regions in the images captured by the camera 102, which image regions in each case correspond to part of the region 210 outside the vehicle 200. The determining unit 104 can then use image points in these image regions as the first image points. The image regions can be processed in the form of first partial image data.

The points in the region 210 outside the vehicle 200 are preferably points 212 on stationary elements. In FIG. 2, the points 212 are points on a tree 214, purely by way of example. On the basis of the first image points and using known methods, for example tracking or optical flow, the determining unit 104 can be used to determine the movement of the display unit 100 in the world coordinates. Furthermore, the determining unit 104 generates first coordinate data which correspond to the movement of the display unit 100 in the world coordinates.

In the method, a movement of the display unit 100 in a coordinate system of the vehicle interior 206 is furthermore determined on the basis of the image data. For example, the image data generated by the camera 102 are processed by the determining unit 104, in order to determine second image points in successive images, which image points correspond to points 216 in the vehicle interior 206. For example, using the image segmentation, the determining unit 104 can determine image regions in the images captured by the camera 102, which image regions in each case correspond to part of the vehicle interior 206. The determining unit 104 can then use image points in these image regions as the second image points. The image regions can be processed in the form of second partial image data. As an alternative or in addition to an image segmentation, a cluster analysis can be used to determine the first image points and the second image points from the image data.

The points 216 in the vehicle interior 206 are preferably stationary. In the embodiment shown in FIG. 2, the points 216 are points on front seats 218 of the vehicle 200, purely by way of example. On the basis of the second image points and using known methods, for example tracking or optical flow, the determining unit 104 can then determine the movement of the display unit 100 in the coordinate system of the vehicle interior 206. Furthermore, the determining unit 104 generates second coordinate data which correspond to the movement of the display unit 100 in the coordinate system of the vehicle interior 206.

The determining unit 104, for example, then determines a movement of the vehicle 200 in the world coordinates from the difference between the first coordinate data and the second coordinate data. Third coordinate data corresponding to the movement of the vehicle 200 in the world coordinates are then generated, by the determining unit 104 for example, and these are made available for further processing. Taking the third coordinate data into account, a position and an orientation of the display unit 100 in the vehicle interior 206 are then determined, by the determining unit 104 for example.

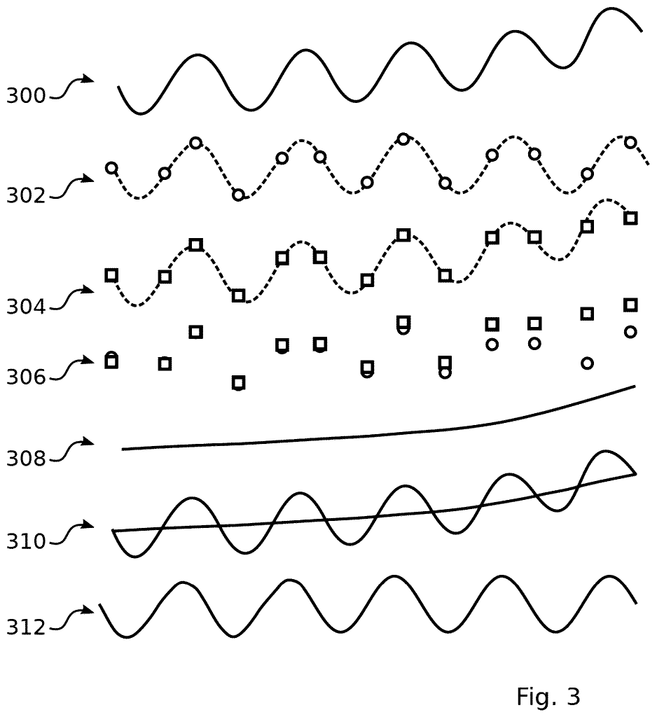

In a schematic depiction, FIG. 3 shows graphs 300, 302, 304, 306, 308, 310, 312 to further illustrate the method according to FIG. 2. Time is depicted on the ordinate of each graph 300, 302, 304, 306, 308, 310, 312. The abscissa of each graph 300, 302, 304, 306, 308, 310, 312 shows an exemplary location component of a movement.

A first graph 300 shows, purely by way of example, a movement of the display unit 100 determined with the aid of the inertial measurement unit 106 of the display unit 100. Since the inertial measurement unit 106 measures the acceleration of the display unit 100 in the stationary reference system, this movement includes the movement of the vehicle 200 and the movement of the display unit 100 in relation to the vehicle interior 206. The inertial measurement unit 106 has a high sampling rate, for example in the region of 100 Hz, therefore the first graph 300 is depicted as a solid line.

A second graph 302 shows, purely by way of example, a movement of the display unit 100 relative to the vehicle interior 206, determined on the basis of the images captured by the camera 102. The second graph 302 thus corresponds to the first coordinate data. The sampling rate of the camera 102 is lower than that of the inertial measurement unit 106. In addition, the image data are difficult to process at a rate of 100 Hz using wearable hardware. The determined movement of the display unit 100 relative to the vehicle interior 206 is therefore depicted by points. The actual movement of the display unit 100 relative to the vehicle interior 206 is depicted by a dashed line.

A third graph 304 shows, purely by way of example, a movement of the display unit 100 relative to the stationary reference system, determined on the basis of the images captured by the camera 102. The third graph 304 thus corresponds to the second coordinate data. The determined movement of the display unit 100 relative to the stationary reference system is depicted by points. The actual movement of the display unit 100 relative to the stationary reference system is depicted by a dashed line.

In a fourth graph 306, the points shown in the second graph 302 and the third graph 304 are shown superimposed. As can be seen in FIG. 3, the movements drift away from one another, since the movement shown in the third graph 304 includes the movement of the vehicle 200. A fifth graph 308 shows the difference between the second graph 302 and the third graph 304, i.e. between the first coordinate data and the second coordinate data. This difference corresponds to the movement of the vehicle 200 relative to the stationary reference system. To obtain a continuous movement of the vehicle 200, the difference can be smoothed, for example by interpolation or use of a Kalman filter. As can be seen clearly in FIG. 3, the movement of the vehicle 200 is less jerky compared to the movement of the display unit 100. Therefore, the low sampling rate of the camera 102 is also sufficient to determine the movement of the vehicle 200 accurately enough.

In a sixth graph 310, the first graph 300, which shows the movement of the display unit 100 relative to the stationary reference system, and the movement of the vehicle 200 relative to the stationary reference system are superimposed. A seventh graph 312 shows the difference between the first graph 300 and the movement of the vehicle 200. This difference corresponds to the movement of the display unit 100 relative to the vehicle interior 206. Since both the movement of the vehicle 200 and the movement of the display unit 100 relative to the stationary reference system were determined with sufficiently high resolution in each case, the movement of the display unit 100 relative to the vehicle interior 206 can be determined from the difference with a high degree of accuracy. Thus the position and the orientation of the display unit 100 relative to the vehicle interior 206 can also be determined very accurately.

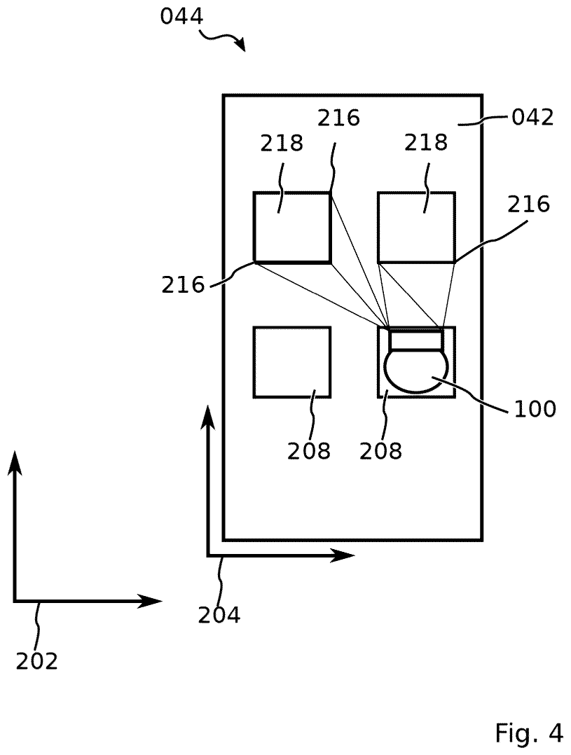

FIG. 4 shows a schematic depiction of the vehicle 200 to illustrate a further embodiment of the method for operating a display unit 100 for extended reality. FIG. 4 furthermore shows the first coordinate axes 202, which belong to the world coordinates of the stationary reference system, and the second coordinate axes 204, which belong to the coordinate system of the vehicle interior 206.

The method is described using the display unit 100 according to FIG. 1 purely by way of example. The display unit 100 is introduced into a vehicle interior 206 of the vehicle 200. In FIG. 4, the display unit 100 is used by the passenger on the rear seat 208 of the vehicle 200, purely by way of example.

The method according to FIG. 4 differs from the method according to FIG. 2 in that the movement of the display unit 100 in relation to the stationary reference system is defined with the aid of the inertial measurement unit 106 of the display unit 100. For example, the determining unit 104 determines the movement of the display unit 100 in relation to the stationary reference system on the basis of acceleration data which are generated by the inertial measurement unit 106 and which correspond to an acceleration of the display unit 100 relative to the stationary reference system.

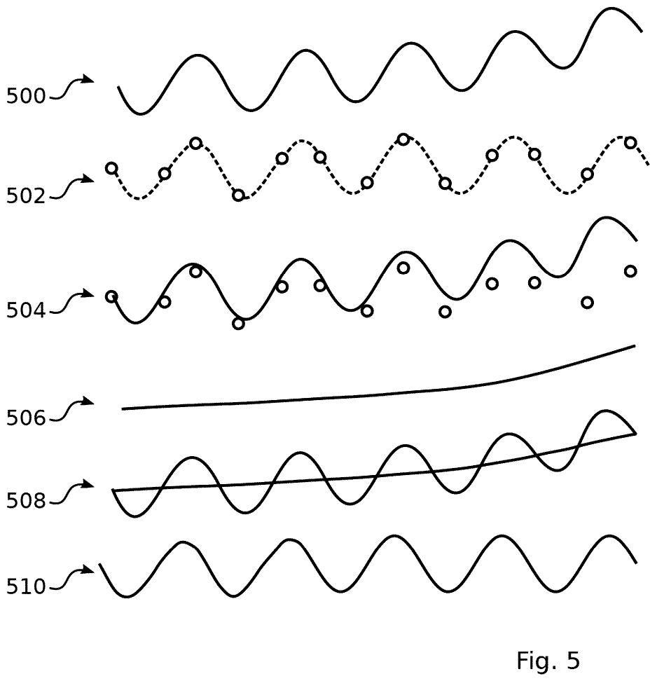

In a schematic depiction, FIG. 5 shows graphs 500, 502, 504, 506, 508, 510 to further illustrate the method according to FIG. 4. Time is depicted on the ordinate of each graph 500, 502, 504, 506, 508, 510. The abscissa of each graph 500, 502, 504, 506, 508, 510 shows an exemplary location component of a movement.

A first graph 500 shows, purely by way of example, a movement of the display unit 100 determined with the aid of the inertial measurement unit 106 of the display unit 100. This movement includes both the movement of the vehicle 200 relative to the stationary reference system and the movement of the display unit 100 in relation to the vehicle interior 206.

A second graph 502 shows, purely by way of example, a movement of the display unit 100 relative to the vehicle interior 206, determined on the basis of the images captured by the camera 102, as points. The second graph 502 corresponds to the first coordinate data. The actual movement of the display unit 100 relative to the vehicle interior 206 is depicted by a dashed line.

In a third graph 504, the first graph 500 and the points of the second graph 502 are shown superimposed. As can be seen in FIG. 5, the movements drift away from one another, since the movement shown in the first graph 500 includes the movement of the vehicle 200 relative to the stationary reference system. A fourth graph 506 shows the difference between the first graph 500 and the points of the second graph 502, i.e. between the first coordinate data and the second coordinate data. This difference corresponds to the movement of the vehicle 200 relative to the stationary reference system.

In a fifth graph 508, the first graph 500, which shows the movement of the display unit 100 relative to the stationary reference system, and the movement of the vehicle 200 relative to the stationary reference system are superimposed. A sixth graph 510 shows the difference between the first graph 510 and the movement of the vehicle 200. This difference corresponds to the movement of the display unit 100 relative to the vehicle interior 206.

In the exemplary embodiments described with reference to FIGS. 1 to 5, at least the camera 102 and the determining unit 104 form the display unit 100 for extended reality. Further elements and features shown in the figures and mentioned in the preceding description can be part of the claimed display unit 100. Likewise, method steps described with reference to the display unit 100 can be part of the claimed method.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

100 display unit
102 camera
104 determining unit
106 inertial measurement unit
108 display element
200 vehicle
202, 204 coordinate axes
206 vehicle interior
208 rear seat
210 region
212 point
214 tree
216 point
218 front seat
300, 302, 304, 306, 308, 310, 312 graph
500, 502, 504, 506, 508, 510 graph

What is claimed is:

1. A method for operating a display unit for extended reality, the method comprising:
introducing the display unit into an interior of a vehicle;
determining a movement of the display unit in world coordinates and generating corresponding first coordinate data;
continuously capturing images with a camera of the display unit, which images include at least part of the vehicle interior, and generating image data corresponding to the images;
determining a movement of the display unit in a coordinate system of the vehicle interior based on the image data, and generating corresponding second coordinate data;
determining a movement of the vehicle in the world coordinates from a difference between the first coordinate data and the second coordinate data, and generating corresponding third coordinate data; and
determining a position and an orientation of the display unit in the vehicle interior factoring into account the third coordinate data.

2. The method according to claim 1, wherein
the movement of the vehicle in the world coordinates is determined from the difference between the first coordinate data and the second coordinate data using a filter and/or a trained machine learning model; and/or
the movement of the display unit in the world coordinates is determined using an inertial measurement unit of the display unit.

3. The method according to claim 1, wherein
the images continuously captured by the camera of the display unit include a region outside the vehicle, and the movement of the display unit in the world coordinates is determined taking the image data into account.

4. The method according to claim 3, wherein
first partial image data are generated from the image data using an image segmentation, which first partial image data correspond to image regions of the images which each include part of the region outside the vehicle, and
the movement of the display unit in the world coordinates is determined taking the first partial image data into account.

5. The method according to claim 3, wherein
the positions of first image points, which correspond to points in the region outside the vehicle, in successive images are determined based on the image data, in order to determine the movement of the display unit in the world coordinates.

6. The method according to claim 5, wherein
the first image points are determined by determining which of the image points correspond to points in the region outside the vehicle using a cluster analysis for a plurality of image points in successive images.

7. The method according to claim 4, wherein
the images continuously captured by the camera of the display unit include a region outside the vehicle, and generating second partial image data from the image data using an image segmentation, which second partial image data correspond to image regions of the images which each include at least part of the vehicle interior, and
the movement of the display unit in the coordinate system of the vehicle interior is determined taking the second partial image data into account.

8. The method according to claim 5, wherein
the positions of second image points, which correspond to points in the vehicle interior, in successive images are determined based on the image data, in order to determine the movement of the display unit in the coordinate system of the vehicle interior;
the second image points are optionally determined by determining which of the image points correspond to points in the vehicle interior using a cluster analysis for a plurality of image points in successive images.

9. A display unit for extended reality, comprising:
a camera configured to continuously capture images and to generate image data corresponding to the images; and
a determining unit operatively configured to:
determine a movement of the display unit in world coordinates and generate corresponding first coordinate data;
determine, based on image data which correspond to images that include at least part of a vehicle interior of a vehicle, a movement of the display unit in a coordinate system of the vehicle interior and generate corresponding second coordinate data;
determine a movement of the vehicle in the world coordinates from a difference between the first coordinate data and the second coordinate data and generate corresponding third coordinate data; and
determine a position and an orientation of the display unit in the vehicle interior taking the third coordinate data into account.

10. The display unit according to claim 9, further comprising:
an inertial measurement unit configured to generate acceleration data which correspond to a movement of the display unit,
wherein the determining unit is further configured to determine the movement of the display unit in the world coordinates taking the acceleration data into account.
